(19) United States
(12) Patent Application Publication
(10) Pub. No.: US 2009/0021666 A1
(43) Pub. Date: Jan. 22, 2009

(54) ELECTRONIC DEVICE, DISPLAY AND MANUFACTURING METHOD THEREOF

(75) Inventor: Hung-Tse Chen, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 11/853,820

(22) Filed: Sep. 12, 2007

(30) Foreign Application Priority Data
Jul. 20, 2007 (TW) 96126587

(51) Int. Cl. G02F 1/1333; G02F 1/13; G02F 1/133

(52) U.S. Cl. 349/58; 349/187; 349/73

(57) ABSTRACT

A display including a flexible display panel and a number of substrates is provided. The flexible display panel has at least a folded region. The substrates are separately arranged at intervals, and the folded region corresponds to an interval between the substrates.

### CROSS-REFERENCE TO RELATED APPLICATION

This application claims the priority benefit of Taiwan application serial no. 96126587, filed Jul. 20, 2007. All disclosure of the Taiwan application is incorporated herein by reference.

### BACKGROUND OF THE INVENTION

1. Field of the Invention

The present invention generally relates to a display and a manufacturing method thereof. More particularly, the present invention relates to a foldable display and a manufacturing method thereof.

2. Description of Related Art

With rapid progress in semiconductor manufacturing techniques, various displays have been continuously launched. To satisfy requirements of lightness, slimness, shortness, compactness, portability, and so on, the displays characterized by pliability and convenience in carrying have become the dominant type in the next generation of the displays. One of the most common displays is a flexible display. In general, the flexible display featuring malleability and bendability can be rolled up and stored when the flexible display is not in use. However, the in-use flexible display is not apt to be fixed in a proper position due to its flexibility, and the display quality is accordingly deteriorated.

As the flexible display is applied to a portable electronic product, the flexible display can be rolled up and stored in the portable electronic product when the flexible display is not in use. Since a user is not able to view display images without pulling out the flexible display, it is rather inconvenient for the user. In addition, a normal user is usually accustomed to the display which is not coiled up. After the user pull out the flexible display, the images displayed thereby are distorted, such that the user may watch the display images with discomfort. Moreover, the display images of the entire flexible display are driven after the flexible display is pulled out. Since it is not very much likely to drive a certain part of the display images, the flexible display is relatively power-consuming.

On account of the above issues, a foldable display proposed by the present invention is able to reduce an area occupied by the display in the electronic products. Each components of the foldable display can be folded as a partition screen and can then be stored up, thus reducing the area occupied by the display and achieving multi-functions. What is more, the foldable display can still perform a display function when it is in a folding state. Further, based on actual demands, the user may spread the foldable display, accomplishing a wide screen effect on the light, slim, short, small and compact electronic device.

### SUMMARY OF THE INVENTION

The present invention is directed to a foldable display which can be folded.

The present invention is further directed to a manufacturing method of a foldable display. The method is adapted to manufacture said foldable display.

The present invention is further directed to an electronic device having a foldable display.

To embody the present invention, a foldable display including a flexible display panel and a plurality of substrates is provided. The flexible display panel has at least a folded region. The substrates are separately arranged at intervals, and the folded region corresponds to an interval between the substrates.

The present invention further provides an electronic device including the foldable display, a body and a moveable supporting mechanism. The body is connected to the foldable display. The movable supporting mechanism is connected to the body and is used for supporting the foldable display which is in a spreading state.

The present invention further provides a manufacturing method of a foldable display. The method includes the following steps. First, a raw substrate is provided. Next, a flexible display panel is formed on the raw substrate. After that, portions of the raw substrate are removed to form a plurality of substrates. The flexible display panel corresponding to each of the removed portions of the raw substrate constructs one folded region.

Through the substrates, the flexible display panel is divided into a plurality of the folded regions, and thus the foldable display disclosed by the present invention has the advantages of being space-saving and portable. Besides, in comparison with the conventional flexible display, the foldable display of the present invention can still perform a display function when it is in a folding state. Hence, using the foldable display in either the folding state or in a spreading state can be determined based on actual demands.

In order to make the aforementioned and other objects, features and advantages of the present invention more comprehensible, several embodiments accompanied with figures are described in detail below.

### BRIEF DESCRIPTION OF THE DRAWINGS

FIG. 1 is a foldable display of the present invention.

FIGS. 1A through 1D illustrate a manufacturing method of a foldable display according to the present invention.

FIG. 2 is a foldable display of the present invention.

FIG. 3 is a schematic view illustrating the foldable display of FIG. 1 after the foldable display is partially folded.

FIG. 4A is a schematic view illustrating the foldable display of FIG. 1 after the foldable display is completely folded.

FIG. 4B is a schematic view illustrating the foldable display of FIG. 1 after the foldable display is completely folded.

FIG. 5A is a schematic view of an electronic device according to the present invention.

FIG. 5B is a side view of FIG. 5A.

### DESCRIPTION OF EMBODIMENTS

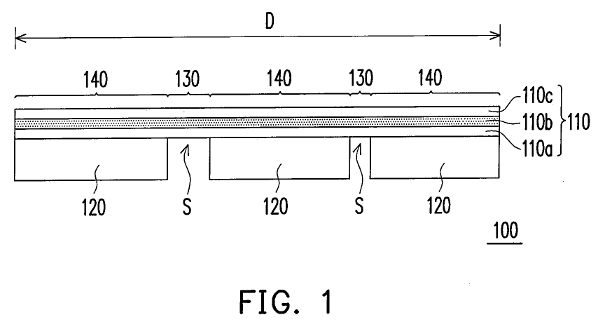

FIG. 1 is a foldable display of the present invention. Referring to FIG. 1, a foldable display 100 includes a flexible display panel 110 and a plurality of substrates 120. The flexible display panel 110 has at least a folded region 130. The substrates 120 are separately arranged at intervals, and the folded region 130 is corresponding to an interval S between the substrates 120. As shown in FIG. 1, the substrates 120 are arranged at inequidistant intervals, while the substrates 120 may be arranged at equidistant intervals in other embodiments.

FIGS. 1A through 1D illustrate a manufacturing method of a foldable display according to the present invention. Referring to FIG. 1A, a raw substrate 122 is provided. The raw substrate 122 is made of a glass substrate, for example. Next, referring to FIG. 1B, the flexible display panel 110 is formed on the raw substrate 122. Thereafter, referring to FIG. 1C, portions A of the raw substrate 122 are removed. The portions A of the raw substrate 122 may be gradually removed as indicated in FIG. 1C or removed at a time. The method of removing the portions A is not limited in the present invention. Finally, referring to FIG. 1D, each of the removed portions A corresponds to one of the intervals S as shown in FIG. 1, and a plurality of substrates 120 is formed by the remained portions of the raw substrate 122. Besides, the flexible display panel 110 corresponding to each of the removed portions A forms one folded region 130. It should be noted that only three substrates 120 are illustrated according to the present embodiment. However, the number of the substrates 120 is not limited in the present invention.

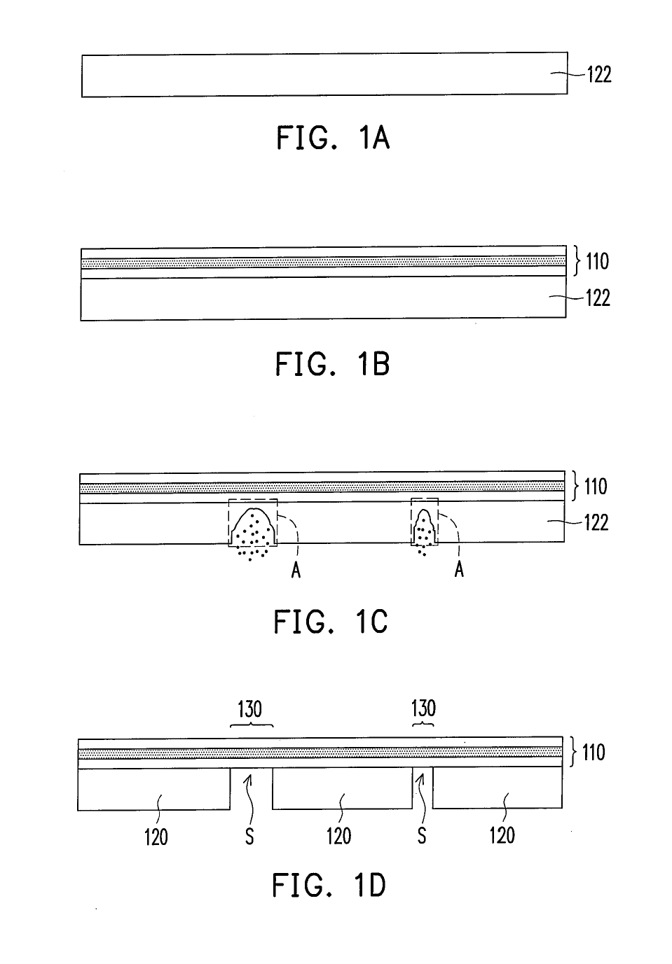

Referring to FIG. 1, the flexible display panel 110 includes a plurality of stacked layers. Specifically, the flexible display panel 110 includes a first flexible film 110a, a second flexible film 110c and a display medium 110b. The first flexible film 110a is adhered to the substrates 120, and the second flexible film 110c is opposite to the first flexible film 110a. The display medium 110b is sandwiched between the first flexible film 110a and the second flexible film 110c. The flexible display panel 110 is formed by the following steps, for example. First, the first flexible film 110a is formed on the raw substrate 122. Next, the second flexible film 110c is formed at an opposite side of the first flexible film 110a. Thereafter, the display medium 110b is formed between the first flexible film 110a and the second flexible film 110c. For example, the flexible display panel 110 may be a liquid crystal display (LCD) panel in the present embodiment. The first flexible film 110a may be a thin film transistor (TFT) array layer composed of a plurality of pixels, and each of the pixels is controlled by at least one TFT. Besides, the display medium 110b may be liquid crystals, for example. By contrast, in other embodiments, the flexible display panel 110 may be an organic luminescent display panel. As depicted in FIG. 2, the organic luminescent display panel is formed by a flexible film 110d adhered to the substrates 120 and by an organic luminescent display array 110e (or an electrophoretic display array) disposed on the flexible film 110d. A method of forming the organic luminescent display panel is similar to the method illustrated in FIGS. 1A through 1D, and thus no further description is provided herein. Note that the flexible display panel 110 may be a transparent display panel, a reflective display panel or a transflective display panel, which is not limited in the present invention. On the other hand, the flexible films 110a, 110c and 110d may be made of polyether sulfone, polyetherimide, polythiophene, phenolic resin, polycarbonate, or any other appropriate material.

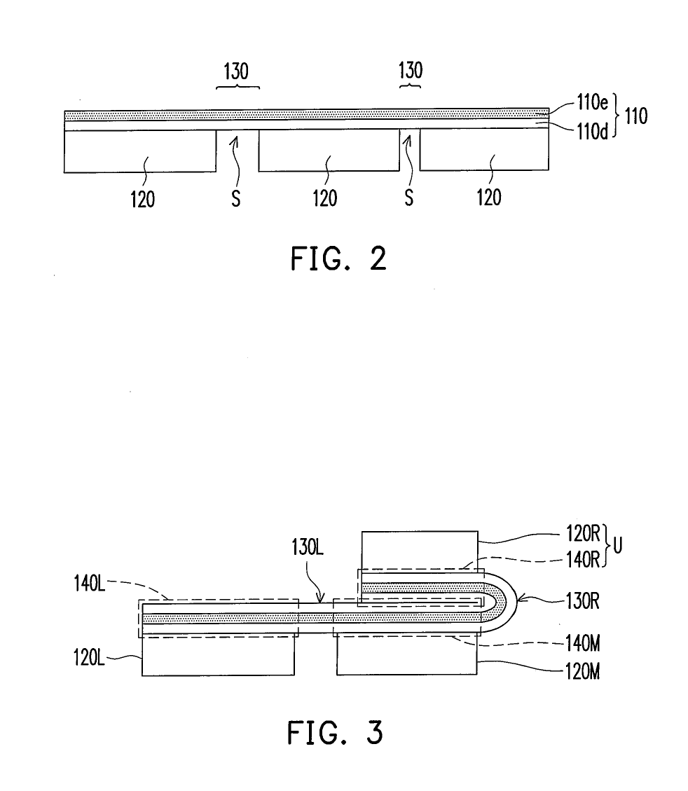

Referring to FIG. 1, in the present embodiment, the flexible display panel 110 has a display region D, and the folded region 130 divides the display region D into a plurality of sub-regions 140 connected to the substrates 120. Each of the sub-regions 140 and the corresponding substrate 120 may be folded toward a direction of the adjacent sub-regions 140 with use of the folded region 130 as a rotation axis. For example, FIG. 3 is a schematic view illustrating the foldable display of FIG. 1 after the foldable display is partially folded. To better demonstrate the present invention, the sub-regions 140 are classified into a right-sided sub-region 140R, a middle sub-region 140M and a left-sided sub-region 140L, while the corresponding substrates 120 are 120R, 120M and 120L, respectively. Moreover, the folded region 130 is divided into a right-sided folded region 130R and a left-sided folded region 130L. Referring to FIG. 3, the right-sided sub-region 140R and the corresponding substrate 120R are taken as a unit U, and the unit U is folded toward a direction of the middle sub-region 140M with use of the right-sided folded region 130R as the rotation axis, such that the substrates 120R and 120M are disposed at respective sides of the right-sided sub-region 140R and the middle sub-region 140M after the unit U is folded. Note that the folding direction of the unit U is not limited in the present invention. The adjacent sub-regions 140 in FIG. 1 and the corresponding substrates 120 may be folded and disposed at respective sides of the substrates 120.

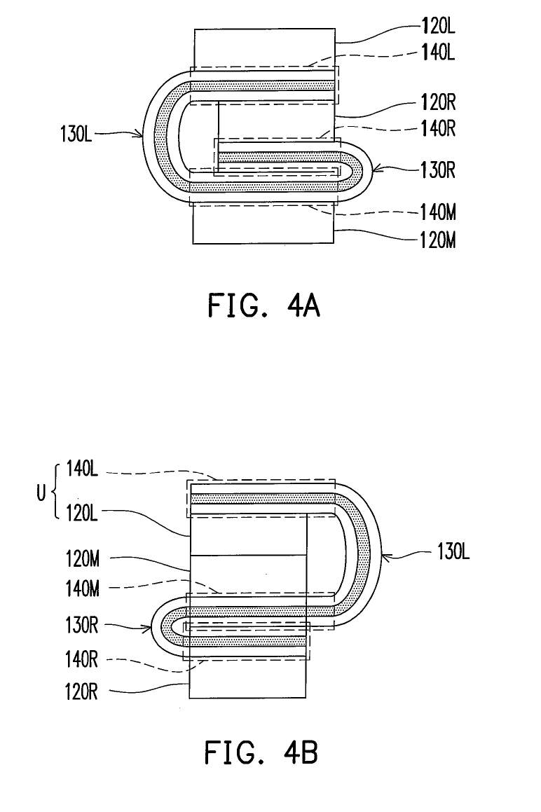

In detail, please refer to FIG. 4A schematically illustrating the foldable display of FIG. 1 after the foldable display is completely folded. Here, FIG. 3 is followed by FIG. 4A schematically depicting the folded foldable display. Referring to FIGS. 3 and 4A, in the present embodiment, the left-sided sub-region 140L and the corresponding substrate 120L are taken as one unit U, and the unit U is folded clockwise with use of the left-sided folded region 130L as the rotation axis, such that the substrates 120M and 120L are disposed at respective sides of the flexible display panel 110 after the foldable display 100 is fully folded.

FIG. 4B is another schematic view illustrating the foldable display of FIG. 1 after the foldable display is completely folded. Here, FIG. 3 is followed by FIG. 4B schematically depicting the folded foldable display. Referring to FIGS. 3 and 4B, in the present embodiment, the left-sided sub-region 140L and the corresponding substrate 120L are taken as one unit U, and the unit U is folded counter-clockwise with use of the left-sided folded region 130L as the rotation axis, such that the left-sided sub-region 140L is disposed at an outermost side of the foldable display 100 after the unit U is fully folded.

It should be noted that the outermost sub-region 140L as shown in FIG. 4B is equipped with a display function. Hence, unlike the conventional flexible display, the foldable display 100 provided by the present invention can still perform the display function even when the foldable display 100 is in a folding state. In practice, the flexible display panel 110 may be integrated with display software when displaying images, such that the images displayed by the flexible display panel 110 may be appropriately portioned out according to whether the foldable display 100 is in the folding state or not. Particularly, as the foldable display 100 is in the folding state, the display software may simply input the images to the outermost sub-region 140L as illustrated in FIG. 4B. In such a displaying mode, not only low power consumption can be achieved, but also a space occupied by the foldable display 100 is reduced. As the foldable display 100 is in a spreading state, the display software may input the images to the entire display region D, such that consecutive frames may be displayed by the sub-regions 140 and the folded region 130 in the display region D, and the quality of the display images can be further improved.

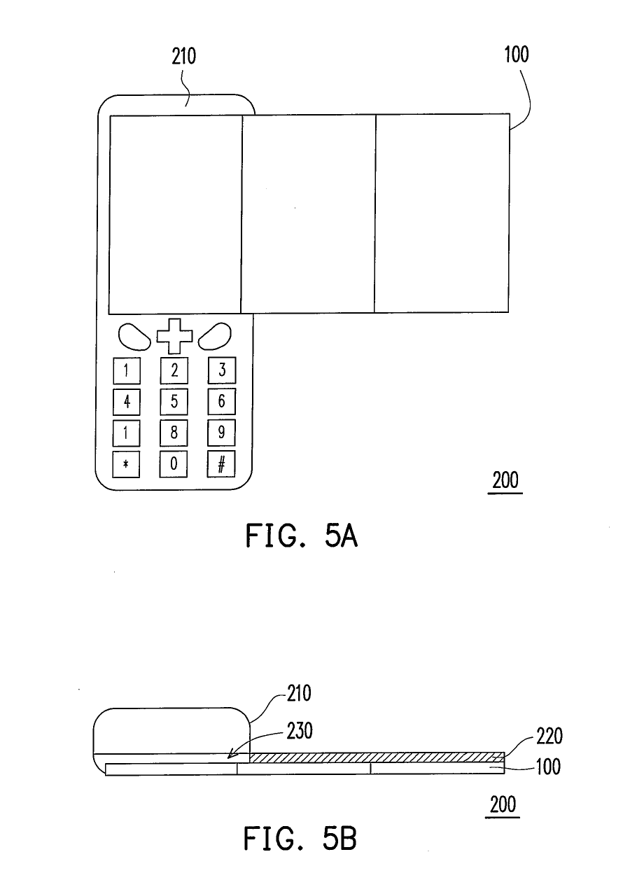

FIG. 5A is a schematic view of an electronic device according to the present invention, and FIG. 5B is a side view of FIG. 5A. In the present embodiment, the foldable display 100 in the spreading state is taken for an example. Referring to FIGS. 5A and 5B, an electronic device 200 includes the foldable display 100, a body 210 and a movable supporting mechanism 220. The body 210 is, for example, a portable electronic device. The body 210 of the electronic device 200 may be a cell phone, a personal digital assistant (PDA), and so forth. Referring to FIG. 5B, the body 210 is connected to the foldable display 100. The movable supporting mechanism 220 is connected to the body 210 and is used for supporting the foldable display 100 in the spreading state. Additionally, in the present embodiment, the body 210 of the electronic device 200 further includes a sliding groove 230 formed therein. The movable supporting mechanism 220 is positioned in the sliding groove 230 and is extended outward through the sliding groove, so as to support the foldable display 100 in the spreading state.

In view of the foregoing, a plurality of the substrates is used in the foldable display of the present invention, such that the flexible display panel is divided into a plurality of the folded regions. Thereby, the foldable display may be configured either in the folding state or in the spreading state under various circumstances. Moreover, in comparison with the conventional flexible display, the foldable display of the present invention can still perform the display function when it is in the folding state. That is to say, the foldable display can be directly used without being pulled out, which brings about convenience and less power consumption. Furthermore, the foldable display in the spreading state can accomplish the wide screen effect, and the quality of the display images is improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A display, comprising:
a flexible display panel having at least a folded region; and
a plurality of substrates separately arranged at intervals, the folded region corresponding to an interval between the substrates.

2. The display of claim 1, wherein the flexible display panel includes a display region, and the folded region divides the display region into a plurality of sub-regions connected to the substrates.

3. The display of claim 1, wherein the substrates are separately arranged at equidistant intervals.

4. The display of claim 1, wherein the substrates include glass substrates.

5. The display of claim 1, wherein the flexible display panel includes a plurality of stacked layers.

6. The display of claim 1, wherein the flexible display panel includes:
a flexible film adhered to the substrates; and
an organic luminescent display array disposed on the flexible film.

7. The display of claim 6, wherein a material of the flexible film includes polyether sulfone, polyetherimide, polythiophene, phenolic resin, or polycarbonate.

8. The display of claim 1, wherein the flexible display panel includes:
a first flexible film adhered to the substrates;
a second flexible film opposite to the first flexible film; and
a display medium sandwiched between the first flexible film and the second flexible film.

9. The display of claim 8, wherein the first flexible film has a plurality of pixels, and each of the pixels has at least a thin film transistor (TFT).

10. The display of claim 8, wherein the display medium includes liquid crystals.

11. The display of claim 8, wherein a material of the first flexible film or the second flexible film includes polyether sulfone, polyetherimide, polythiophene, phenolic resin, or polycarbonate.

12. The display of claim 1, wherein the flexible display panel includes:
a flexible film adhered to the substrates; and
an electrophoretic display array disposed on the flexible film.

13. The display of claim 12, wherein a material of the flexible film includes polyether sulfone, polyetherimide, polythiophene, phenolic resin, or polycarbonate.

14. The display of claim 1, wherein the flexible display panel includes a reflective display panel.

15. An electronic device, comprising:
a display as claimed in claim 1;
a body connected to the foldable display; and
a movable supporting mechanism connected to the body and used for supporting the display.

16. The electronic device of claim 15, wherein the body comprises a sliding groove, the movable supporting mechanism is positioned in the sliding groove and is extended outward through the sliding groove, so as to support the display.

17. The electronic device of claim 15, wherein the body includes a portable electronic device.

18. The electronic device of claim 17, wherein the portable electronic device includes a cell phone or a personal digital assistant (PDA).

19. A manufacturing method of a display, comprising:
providing a raw substrate;
forming a flexible display panel on the raw substrate; and
removing portions of the raw substrate to form a plurality of substrates, wherein the flexible display panel corresponding to each of the removed portions of the raw substrate forms one folded region.

20. The manufacturing method of the display of claim 19, wherein the method of forming the flexible display panel includes:
forming a flexible film on the raw substrate; and
forming an organic luminescent display array on the flexible film.

21. The manufacturing method of the display of claim 19, wherein the method of forming the flexible display panel includes:
forming a first flexible film on the raw substrate;
forming a second flexible film at an opposite side of the first flexible film; and
forming a display medium between the first flexible film and the second flexible film.

22. The manufacturing method of the display of claim 21, wherein the display medium includes liquid crystals.

23. The manufacturing method of the display of claim 19, wherein the method of forming the flexible display panel includes:
forming a flexible film on the raw substrate; and
forming an electrophoretic display array on the flexible film.
